(19) United States
(12) Patent Application Publication
(10) Pub. No.: US 2014/0265058 A1
(43) Pub. Date: Sep. 18, 2014

(54) SYSTEM AND METHOD FOR MANEUVERING THIN PLY TECHNOLOGY COMPLEXES

(71) Applicant: NORTH THIN PLY TECHNOLOGY LLC, Penthalaz (CH)

(72) Inventors: Gérard Gautier, Yens (CH); Wayne Smith, Yverdon (CH)

(73) Assignee: North Thin Ply Technology LLC, Penthalaz (CH)

(21) Appl. No.: 13/798,992

(22) Filed: Mar. 13, 2013

(51) Int. Cl. B29C 43/12

(52) U.S. Cl. CPC B29C 43/12
USPC 264/553

(57) ABSTRACT

A method for maneuvering a flexible pre-impregnated composite sheet is disclosed. The flexible pre-impregnated composite sheet is positioned onto a work surface and a vacuum sheet is operatively coupled to the flexible pre-impregnated composite sheet. The vacuum sheet is operatively coupled to a flexible conveyor sheet and the flexible conveyor sheet is positioned proximate to a mold such that the flexible pre-impregnated composite sheet is in contact with the mold. The vacuum sheet is decoupled from the flexible conveyor sheet and the vacuum sheet is removed from the flexible pre-impregnated composite sheet after the debulking of the flexible pre-impregnated composite sheet(s).

### BACKGROUND

The present invention relates generally to the field of thin ply technology complexes. More particularly, the present invention relates to systems and methods for maneuvering flexible pre-impregnated composite sheets.

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Various composites are known commercially for forming structures that must be strong yet lightweight. One such composite is a prepreg composite (“prepreg”). Prepregs are specially formulated resin matrix systems that are reinforced with filaments constructed of carbon, glass, aramid or the like. The filaments are embedded in a thermoset resin that cures at elevated temperature and pressure, undergoing a chemical reaction that transforms the prepreg into a solid structural material that is durable, temperature resistant, stiff, and lightweight.

Prepregs are generally comprised of a plurality of unidirectional or woven prepreg tapes. In a unidirectional prepreg tape, filaments are aligned parallel to each other and embedded in a thermoset resin. In a woven prepreg tape, filaments are woven and embedded in a thermoset resin. Both types of prepreg tapes are commercially available, for example, under the under the trademark HexPly by Hexcel.

To form a structure, one or more layers of prepreg tape are positioned to form a “complex” or “preform.” Once one or more complexes are positioned in a three-dimensional mold, it is cured using heat and pressure.

One known method for positioning complexes in a three-dimensional mold is by laying the prepreg tape in the mold by hand. Another known method is by using three-dimensional automated tape layer (“ATL”) machines that place the prepreg tape directly into a mold such as those available from Coriolis Composites or Ingersoll Machines Tools. Both methods, however, add significant expense to creating a prepreg composite structure. In particular, manually laying prepreg tape in molds is very labor intensive, which significantly increases the labor cost associated with creating a prepreg composite structure. Fully automated three-dimensional ATL machines significantly reduce the labor required to create a prepreg composite structure, but the high cost of the three-dimensional ATL machines increases the cost of creating a prepreg composite structure. Three-dimensional ATL machines may also be too expensive for some companies to acquire and, for those that can afford them, the high cost will likely mean that the machines are limited to commercially viable structures such as expensive, low-production structures or lower-cost, high-production structures.

### SUMMARY

Various embodiments of the present invention relate to systems and methods for constructing and maneuvering flexible pre-impregnated composite sheets. In general, embodiments of the system comprise a work surface, an automated tape layer (“ATL” or “tape layer”) machine for constructing a flexible pre-impregnated composite sheet comprised of at least one layer of prepreg tape on the work surface, a mold for forming rigid structures from the flexible pre-impregnated composite sheets, and a conveyor for maneuvering the flexible pre-impregnated composite sheets from the work surface to the mold.

In one embodiment, a method for maneuvering a flexible pre-impregnated composite sheet is disclosed. The method comprises positioning the flexible pre-impregnated composite sheet onto a work surface and operatively coupling a vacuum sheet to the flexible pre-impregnated composite sheet. The vacuum sheet is operatively coupled to a flexible conveyor sheet and the flexible conveyor sheet is positioned proximate to a mold such that the flexible pre-impregnated composite sheet is in contact with the mold. The vacuum sheet is decoupled from the flexible conveyor sheet and removed from the flexible pre-impregnated composite sheet.

In another embodiment, a method for forming a rigid composite structure is disclosed. The method comprises providing a flexible pre-impregnated composite sheet comprised of at least one layer of prepreg tape and a flexible conveyor sheet, the flexible conveyor sheet having a first lateral side, a second lateral side, and one or more connecting sides connecting the first lateral side and the second lateral side. The flexible pre-impregnated composite sheet is positioned onto and coupled to the flexible conveyor sheet. The flexible conveyor sheet is supported along at least a portion of the first and second connecting sides but not supported on the lateral sides. The flexible conveyor sheet is positioned proximate to a mold such that the flexible pre-impregnated composite sheet is in contact with the mold. Once in the mold, the flexible pre-impregnated composite sheet is cured until it becomes a rigid composite structure.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 illustrates a flexible pre-impregnated composite sheet disposed on a work surface;

FIG. 2 illustrates breather strips and release strips disposed on the flexible pre-impregnated composite sheet of FIG. 1;

FIG. 3 illustrates a vacuum sheet disposed on the flexible pre-impregnated composite sheet, release strips, and breather strips of FIG. 2;

FIG. 4 illustrates a flexible conveyor sheet being lowered onto the flexible pre-impregnated composite sheet, release strips, breather strips, and vacuum sheet of FIG. 3;

FIG. 5 illustrates the flexible conveyor sheet of FIG. 4 lowered onto the flexible pre-impregnated composite sheet, release strips, breather strips, and vacuum sheet of FIG. 3;

FIG. 6 illustrates a conveyor lifting the flexible conveyor sheet, flexible pre-impregnated composite sheet, release strips, breather strips, and vacuum sheet of FIG. 5 and maneuvering the same proximate to a mold;

FIG. 7 illustrates the removal of a backing sheet from the flexible pre-impregnated composite sheet;

FIG. 8 illustrates the flexible conveyor sheet, flexible pre-impregnated composite sheet, release strips, breather strips, and vacuum sheet of FIG. 7 lowered into a mold, and the vacuum sheet being positioned proximate to the mold;

FIG. 9 illustrates the edges of the vacuum sheet of FIG. 8 being coupled to the mold;

FIG. 10 illustrates the flexible conveyor sheet of FIG. 9 being lifted, leaving the flexible pre-impregnated composite sheet, release strips, breather strips, and vacuum sheet of FIG. 10 in the mold;

FIG. 11 illustrates the flexible pre-impregnated composite sheet of FIG. 1 disposed on the mold; and

FIG. 12 is a flow chart illustrating the construction and maneuvering of a flexible pre-impregnated composite sheet constructed in accordance with an embodiment of the present invention.

### DETAILED DESCRIPTION OF EXEMPLARY EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

FIG. 1 illustrates a flexible pre-impregnated composite sheet 1 constructed in accordance with an embodiment of the present invention disposed on a work surface 5. The details of constructing the flexible pre-impregnated composite sheet 1 are known in the art and not the focus of the present disclosure. As one non-limiting example for background purposes, however, the flexible pre-impregnated composite sheet 1 may be constructed of a plurality of prepreg tape to form a layer, where multiple layers are referred to as “complexes” or “performs.” The prepeg tape comprises filaments encased in resin such as epoxy. The tape may be plotted directly onto the work surface 5 by, for example, an automated tape laying machine (“ATL” or “tape layer”). Alternatively, the prepreg tape may be plotted on a backing sheet 3 disposed on the work surface 5 to facilitate easy removal of the flexible pre-impregnated composite sheet 1 from work surface 5. In an exemplary embodiment, the backing sheet 3 is constructed of flexible silicone to allow the backing sheet 3 to be easily removed from the flexible pre-impregnated composite sheet 1. However, other materials such as polyethylene may also be used, so long as the material permits the backing sheet 3 to be easily removed from the flexible pre-impregnated composite sheet 1.

Once the flexible pre-impregnated composite sheet 1 is disposed on the work surface 5 as illustrated in FIG. 1, it may be prepared for transferring to a mold 29 for forming into a rigid composite structure. With reference to FIG. 2, release strips 7 and breather strips 9 are disposed on the flexible pre-impregnated composite sheet 1. As shown in FIG. 3 and described in further detail below, a vacuum sheet 11 is placed over the flexible pre-impregnated composite sheet 1 for debulking the flexible pre-impregnated composite sheet 1. The flexible pre-impregnated composite sheet 1 is comprised of a resin to provide a tacky surface. The release strips 7 provide an area on which the vacuum sheet 11 will not stick to the flexible pre-impregnated composite sheet 1. If the vacuum sheet 11 were coupled to the entire surface area of the flexible pre-impregnated composite sheet 1, it would be difficult to remove and air would be unable to flow between the flexible pre-impregnated composite sheet 1 and the vacuum sheet 11. By providing an area of the flexible pre-impregnated composite sheet 1 to which the vacuum sheet 11 does not stick, the release strips 7 also increase the ease with which the vacuum sheet 11 is removed from the flexible pre-impregnated composite sheet 1. In addition, the release strips 7 facilitate air flow between the vacuum sheet 11 and the flexible pre-impregnated composite sheet 1, which is important to the debulking step explained in further detail below. In an exemplary embodiment, the release strips are constructed of polyethylene. However, the release strips 7 may be constructed of other suitable materials such as polypropelyne, polyethelyne, polyethylene terephthalate, silicone, wax paper, or parchment paper.

Similar to the release strips 7, the breather strips 9 facilitate air flow between the vacuum sheet 11 and the flexible pre-impregnated composite sheet 1 during the debulking step described below. In an exemplary embodiment, the breather strips 9 are constructed of polyethylene, are slightly thicker than the release strips 7, and comprise a honeycomb geometry. The honeycomb geometry helps to facilitate airflow between the vacuum sheet 11 and the flexible pre-impregnated composite sheet 1 when the volume between the vacuum sheet 11 and the flexible pre-impregnated composite sheet 1 is subjected to a vacuum during the debulking step. The honeycomb geometry also facilitates airflow by resisting compression when the volume between the vacuum sheet 11 and the flexible pre-impregnated composite sheet 1 is subjected to a vacuum during the debulking step. Other materials and geometries may be suitable, so long as they are generally porous and incompressible to maintain an air passage between the vacuum sheet 11 and the flexible pre-impregnated composite sheet 1 during the debulking step.

After the release strips 7 and breather strips 9 are disposed on the flexible pre-impregnated composite sheet 1, a vacuum sheet 11 is disposed on the flexible pre-impregnated composite sheet 1 as illustrated in FIG. 3. In an exemplary embodiment, the vacuum sheet 11 may be used to debulk the flexible pre-impregnated composite sheet 1 on the work surface 5. In such an embodiment, an end of a vacuum hose (not shown) is inserted between the flexible pre-impregnated composite sheet 1 and the vacuum sheet 11 and the edges of the vacuum sheet 11 are coupled to the work surface 5 to create a substantially airtight volume. The vacuum, via the vacuum hose, draws the air from the volume between the flexible pre-impregnated composite sheet 1 and the vacuum sheet 11 to remove any air voids in the pre-impregnated composite sheet 1.

After debulking the flexible pre-impregnated composite sheet 1 on the work surface 5, the flexible pre-impregnated composite sheet 1 may be coupled to the conveyor 13 for transferring to the mold 29. Before describing the process of transferring the flexible pre-impregnated composite sheet 1 from the work surface 5 to the mold 29, however, a description of an embodiment of the conveyor 13 is provided. In the embodiment illustrated in FIGS. 4-10, the conveyor 13 comprises a hoist 15 coupled to flexible conveyor sheet 17. In the embodiment illustrated in FIG. 4, the flexible conveyor sheet 17 is coupled to and suspended from the hoist 15, for example, by cables 27. The conveyor 13 is configured to translate along orthogonal axes for positioning the hoist 15, and the hoist 15 is configured to raise and lower the flexible conveyor sheet 17.

With reference to FIG. 4, the flexible conveyor sheet 17 comprises first and second connecting sides 19, 21 and first and second lateral sides 23, 25. The flexible conveyor sheet 17 is coupled to the hoist 15 by cables 27 coupled to the first and second connecting sides 19, 21, such that the first and second connecting sides 19, 21 are supported and the first and second lateral sides 23, 25 are not supported. Because the conveyor sheet 17 is flexible, the unsupported first and second lateral sides 23, 25 bend or sag under their own weight when lifted as illustrated in FIG. 4.

In yet another embodiment, the conveyor 13 comprises a heating device integrated or in thermal communication with the flexible conveyor sheet 17. For example, the heating device may be coupled to the upper or lower side of the flexible conveyor sheet 17. The heating device is configured to adjust the temperature of the flexible pre-impregnated composite sheet 1. In an exemplary embodiment, the heating device generates heat sufficient to increase the temperature of the flexible pre-impregnated composite sheet 1 from about 20 degrees Celsius to about 35 degrees Celsius. Adjusting the temperature of the flexible pre-impregnated composite sheet 1 manipulates the tackiness of the resin for purposes of uncoupling components from or coupling components to the flexible pre-impregnated composite sheet 1.

With reference to FIGS. 4 and 5, after debulking the flexible pre-impregnated composite sheet 1 on the work surface 5, the flexible conveyor sheet 17 is lowered onto the flexible pre-impregnated composite sheet 1. Once in contact, the flexible pre-impregnated composite sheet 1 is coupled to the flexible conveyor sheet 17 via the vacuum sheet 11. In particular, as illustrated in FIG. 5, the edges of the vacuum sheet 11 are coupled to the first and second connecting sides 19, 21 of the flexible conveyor sheet 17. The vacuum sheet 11 may be coupled to the flexible conveyor sheet 17 a variety of ways. In one exemplary embodiment, the vacuum sheet 11 is coupled to the flexible conveyor sheet 17 by disposing double-sided tape between the edges of the vacuum sheet 11 and the flexible conveyor sheet 17. In another embodiment, the vacuum sheet 11 is coupled to the flexible conveyor sheet 17 by sandwiching the edges of the vacuum sheet 11 and flexible conveyor sheet 17 between magnets. In yet another embodiment, silicone molding with a channel disposed therein is used to couple the vacuum sheet 11 to the flexible conveyor sheet 17. In this embodiment, the molding is coupled to the flexible conveyor sheet 17 and the edges of the vacuum sheet 11 are disposed within the mold channel. A tube with a cross-section corresponding to the cross-section of the mold channel is then pressed into the mold channel, such that the interference fit between the mold channel and the tube secures the edges of the vacuum sheet 11 within the mold channel. In yet another embodiment, the vacuum sheet 11 is coupled to the flexible conveyor sheet by vacuum pressure.

While the foregoing describes how the vacuum sheet 11 is coupled to the flexible conveyor sheet 17, it is important to note that coupling the vacuum sheet 11 to the flexible conveyor sheet 17 serves to indirectly couple the flexible pre-impregnated composite sheet 1 to the flexible conveyor sheet 17. In particular, because the flexible pre-impregnated composite sheet 1 is tacky, the vacuum sheet 11 sticks to it. Accordingly, coupling the vacuum sheet 11 to the flexible conveyor sheet 17 indirectly couples the flexible pre-impregnated composite sheet 1 to the flexible conveyor sheet 17.

Once the flexible pre-impregnated composite sheet 1 is coupled to the flexible conveyor sheet 17 via the vacuum sheet 11, the flexible pre-impregnated composite sheet 1 is lifted from the work surface 5 and moved proximate to the mold 29 as illustrated in FIG. 6. With reference to FIG. 7, the backing sheet 3 is removed before lowering the flexible pre-impregnated composite sheet 1 into the mold 29. With the backing sheet 3 removed, the flexible pre-impregnated composite sheet 1 is lowered into the mold 29 and the vacuum sheet 11 is decoupled from the flexible conveyor sheet 17 as illustrated in FIG. 8.

As noted above, because the conveyor sheet 17 is flexible, the unsupported first and second lateral sides 23, 25 bend or sag under their own weight when lifted as illustrated in FIG. 4. Because the flexible pre-impregnated composite sheet 1, once coupled to the conveyor sheet 17, is on the outside of the flexible conveyor sheet 17, the sagging causes the flexible pre-impregnated composite sheet 1 to pre-tension. This pre-tensioning causes the flexible pre-impregnated composite sheet 1 to become more smooth and less prone to wrinkling.

One benefit of coupling the flexible pre-impregnated composite sheet 1 to the conveyor sheet 17 via the vacuum sheet 11 is that the flexible pre-impregnated composite sheet 1 may be debulked again once in the mold 29. In such an embodiment, an end of a vacuum hose (not shown) is inserted between the flexible pre-impregnated composite sheet 1 and the vacuum sheet 11 and, as illustrated in FIG. 9, the edges of the vacuum sheet 11 are coupled to the mold 29 to create a substantially airtight volume. The flexible conveyor sheet 17 is then lifted from the mold 29 as illustrated in FIG. 10 and the vacuum, via the vacuum hose, draws the air from the volume between the flexible pre-impregnated composite sheet 1 and the vacuum sheet 11.

Once debulking is complete, the vacuum sheet 11, release strips 7, and breather strips 9 are removed from the flexible pre-impregnated composite sheet 1 as illustrated in FIG. 11. With the flexible pre-impregnated composite sheet 1 disposed in the mold 29, the process can be repeated as necessary to fill the mold and/or achieve the desired number of layers of flexible pre-impregnated composite sheet 1 as illustrated in FIG. 12.

Once the desired number of layers of flexible pre-impregnated composite sheet 1 are placed in the mold 29, the preform comprising the layers of flexible pre-impregnated composite sheet 1 may be cured by heat and pressure to transform the flexible preform into a rigid preform.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments, and with various modifications, as are suited to the particular use contemplated.

The construction and arrangements of the systems and methods for maneuvering flexible pre-impregnated composite sheets, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

Various embodiments are described in the general context of method steps, which may be implemented in one embodiment by a program product including computer-executable instructions, such as program code, executed by computers in networked environments. Generally, program modules include routines, programs, objects, components, data structures, etc., that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

What is claimed is:

1. A method for maneuvering a flexible pre-impregnated composite sheet, comprising:
positioning the flexible pre-impregnated composite sheet onto a work surface;
operatively coupling a vacuum sheet to the flexible pre-impregnated composite sheet;
operatively coupling the vacuum sheet to a flexible conveyor sheet;
positioning the flexible conveyor sheet proximate to a mold such that the flexible pre-impregnated composite sheet is in contact with the mold;
decoupling the vacuum sheet from the flexible conveyor sheet; and
removing the vacuum sheet from the flexible pre-impregnated composite sheet.

2. The method of claim 1, wherein the flexible conveyor sheet comprises first and second lateral sides, and one or more connecting sides, and wherein the step of operatively coupling the vacuum sheet to the flexible conveyor sheet comprises supporting the flexible conveyor sheet along at least a portion of the first and second connecting sides and not supporting the lateral sides.

3. The method of claim 2, wherein the flexible conveyor sheet comprises:
a hoist;
a conveyor frame operatively connected to the hoist; and
wherein the flexible conveyor sheet is operatively connected to the conveyor frame.

4. The method of claim 1, further comprising the step of positioning one or more release strips on the side of the flexible pre-impregnated composite sheet not in contact with the work surface.

5. The method of claim 4, further comprising the step of positioning one or more breather strips on the side of the flexible pre-impregnated composite sheet not in contact with the work surface, wherein the one or more breather strips are configured to permit air flow between the flexible pre-impregnated composite sheet and the vacuum sheet.

6. The method of claim 5, wherein the one or more breather strips are disposed on the one or more release strips.

7. The method of claim 5, wherein the step of operatively coupling the vacuum sheet to the flexible pre-impregnated composite sheet further comprises the step of sealably coupling the edges of the vacuum sheet to the work surface and generating a vacuum within the volume between the vacuum sheet and the flexible pre-impregnated composite sheet.

8. The method of claim 5, wherein the step of operatively coupling the vacuum sheet to the flexible conveyor sheet further comprises sealably coupling the edges of the vacuum sheet to the conveyor frame.

9. The method of claim 5, further comprising the step of removing at least one of the one or more release strips, and the step of removing at least one of the one or more breather strips.

10. The method of claim 1, further comprising the step of curing the flexible pre-impregnated composite sheet until it becomes a rigid pre-impregnated composite sheet.

11. The method of claim 1, further comprising the step of increasing the temperature of the flexible pre-impregnated composite sheet by applying heat.

12. The method of claim 1, further comprising the step of increasing the temperature of the flexible pre-impregnated composite sheet to a temperature in the range of about 20 degrees Celsius to about 35 degrees Celsius.

13. The method of claim 3, wherein the conveyor further comprises a heating device coupled to the flexible conveyor sheet, wherein the heating device is configured to increase the temperature of the flexible pre-impregnated composite sheet.

14. The method of claim 1, wherein the vacuum sheet at least partially adheres to the flexible pre-impregnated composite sheet.

15. A method for forming a rigid composite structure, the method comprising:
providing a flexible pre-impregnated composite sheet and a flexible conveyor sheet, the flexible conveyor sheet having a first lateral side, a second lateral side, and one or more connecting sides connecting the first lateral side and the second lateral side;
positioning the flexible pre-impregnated composite sheet onto the flexible conveyor sheet;
coupling the flexible pre-impregnated composite sheet to the flexible conveyor sheet;
supporting the flexible conveyor sheet along at least a portion of the first and second connecting sides and not supporting the lateral sides;
positioning the flexible conveyor sheet proximate to a mold such that the flexible pre-impregnated composite sheet is in contact with the mold;
curing the flexible pre-impregnated composite sheet until it becomes the rigid composite structure.

16. The method of claim 15, further comprising the step of operatively coupling a vacuum sheet to the flexible pre-impregnated composite sheet, wherein the vacuum sheet is disposed between the flexible pre-impregnated composite sheet and the flexible conveyor sheet.

17. The method of claim 16, wherein the vacuum sheet sticks to the flexible pre-impregnated composite sheet.

18. The method of claim 17, further comprising the step of positioning one or more release strips and one or more breather strips between the flexible pre-impregnated composite sheet and the vacuum sheet, wherein the one or more breather strips are configured to permit air flow between the flexible pre-impregnated composite sheet and the vacuum sheet.

19. The method of claim 18, further comprising the step of operatively coupling the vacuum sheet to the flexible conveyor sheet.

20. The method of claim 19, further comprising the step of removing the vacuum sheet from the flexible pre-impregnated composite sheet.
